(19) United States
(12) Patent Application Publication
(10) Pub. No.: US 2016/0363762 A1
(43) Pub. Date: Dec. 15, 2016

(54) DISPLAY DEVICE

(71) Applicant: SHARP KABUSHIKI KAISHA, Sakai City, Osaka (JP)

(72) Inventors: Emi YAMAMOTO, Sakai-shi (JP); Tsuyoshi MAEDA, Sakai-shi (JP)

(21) Appl. No.: 15/121,559

(22) PCT Filed: Feb. 25, 2015
(86) PCT No.: PCT/JP2015/055456

§ 371 Date: Aug. 25, 2016

(30) Foreign Application Priority Data
Feb. 26, 2014 (JP) 2014-035173

(51) Int. Cl. G02B 26/04; G02B 5/00; G02B 5/02

(52) U.S. Cl. CPC G02B 26/04; G02B 5/0257; G02B 5/0278; G02B 5/003

(57) ABSTRACT

A MEMS display device (1) is provided with a display unit (14), and a light control film (9) which controls a light distributing property of light which is output from the display unit (14), in which the display unit (14) includes a backlight (11), an aperture layer (22) which includes an opening (24) which transmits light output from the backlight (11), and a shutter (23) which is movable with respect to the opening (24), and performs switching between transmitting of light through the opening (24) and shielding.

### TECHNICAL FIELD

The present invention relates to a display device.

This application claims priority based on Japanese Patent Application No. 2014-035173 filed on Feb. 26, 2014 in Japan and contents thereof are herein incorporated.

### BACKGROUND ART

In recent years, a display to which a micro electro mechanical systems (MEMS) technology is applied has been proposed. The MEMS display includes a shutter (movable portion) which is formed on a substrate using a semiconductor process technology, and in which display is performed when the shutter is opened/closed at high speed, and light from a backlight is transmitted through an opened portion of the shutter. In the MEMS display, light directly from the backlight is regulated by an opening/closing operation of the shutter.

### CITATION LIST

### Patent Literature

PTL 1: Japanese Unexamined Patent Application Publication (Translation of RCT Application) No. 2010-517072

### SUMMARY OF INVENTION

### Technical Problem

In the MEMS display, there is a case in which reflection of outside light due to metal wiring and a metal shutter formed on a substrate has a major influence on display. A configuration in which a circular polarizer is adopted has been proposed in order to suppress such influence; however, since light of the backlight is also cut, there is a problem in that display becomes dark. In addition, since a MEMS element has a shutter function alone, luminance unevenness in the backlight appears directly as display unevenness.

An aspect of the invention has been made in consideration of the above described problem in the related art, and one object thereof is to provide a display device in which it is possible to perform display with high viewability by suppressing reflection due to outside light, and to suppress display unevenness by suppressing luminance unevenness.

### Solution to Problem

A display device according to one aspect of the invention includes a display unit and a light control film configured to control a light distributing property of light output from the display unit. The display unit includes a lighting unit, a light transmitting member with an opening that transmits light output from the lighting unit, and a shutter that is movable with respect to the opening and performs switching between transmitting and shielding of light through the opening. The light control film includes a base member having light permeability, a light diffusing portion formed on a first face of the base member, and a light shielding layer formed in a region other than a region where the light diffusing portion is formed on the first face of the base member. The light diffusing portion includes a light output end face in contact with the base member, and a light input end face that is opposite the light output end face and has an area larger than that of the light output end face, in which a height from the light input end face to the light output end face is larger than a thickness of the light shielding layer.

In the display device according to the aspect of the invention, the shutter may be made of a material having light reflectivity.

In the display device according to the aspect of the invention, the light control film may have a configuration in which light input from the light input end face is anisotropically diffused in an azimuth angle direction which is viewed from a direction normal to the base member.

The display device according to the aspect of the invention may have a configuration in which the light shielding layer is configured of a plurality of light shielding layers, and a planar shape of the light shielding layers which is viewed from the direction normal to the base member is an anisotropic shape with a long axis and a short axis.

The display device according to the aspect of the invention may have a configuration in which an azimuth angle direction in which intensity of light output from the display unit is low and an azimuth angle direction in which a light diffusing property of the light control film is relatively high substantially match.

The display device according to the aspect of the invention may have a configuration in which the opening is configured of a plurality of openings which are arranged in matrix in a first direction and a second direction, and one of the first direction and the second direction, which is a direction in which an interval between the openings adjacent to each other is small, and the azimuth angle direction in which the light diffusing property of the light control film is relatively high substantially match.

### Advantageous Effects of Invention

According to one aspect of the invention, a display device is provided in which it is possible to perform bright display by suppressing reflection of outside light and to suppress display unevenness by suppressing luminance unevenness.

### BRIEF DESCRIPTION OF DRAWINGS

FIG. 1 is a diagram illustrating a schematic configuration of a MEMS display device according to a first embodiment.

FIG. 2 is a sectional view illustrating a schematic configuration of the MEMS display device.

FIG. 3A is a diagram illustrating a shutter operation of a shutter assembly and illustrating a closed state of the shutter assembly.

FIG. 3B is a diagram illustrating a shutter operation of the shutter assembly and illustrating an open state of the shutter assembly.

FIG. 4 is a perspective view illustrating a configuration of a light control film.

FIG. 5A is a sectional view (sectional view in ZX directions) illustrating the light control film.

FIG. 5B is a plan view (plan view in XY directions) of the light control film.

FIG. 6A is a diagram illustrating a result of measuring a light distributing property (light distributing angle-luminance) of a MEMS display device in order to prove an effect of the light control film, and illustrating a light distributing property of a MEMS display device (not having light control film) in the related art.

FIG. 6B is a diagram illustrating a result of measuring a light distributing property (light distributing angle-luminance) of a MEMS display device in order to prove an effect of the light control film, and illustrating a light distributing property of the MEMS display device (having light control film) in the first embodiment.

FIG. 7 is a perspective view illustrating a MEMS display device according to a second embodiment.

FIG. 8A is a first diagram describing a shape of a light shielding layer of a light control film and reflection of light on a side face of a light diffusing portion.

FIG. 8B is a second diagram describing a shape of the light shielding layer of the light control film and reflection of light on the side face of the light diffusing portion.

FIG. 8C is a third diagram describing a shape of the light shielding layer of the light control film and reflection of light on the side face of the light diffusing portion.

### DESCRIPTION OF EMBODIMENTS

Hereinafter, embodiments of the invention will be described with reference to drawings. In the drawings which will be described below, scales of members are appropriately changed so that each member is recognizable.

### First Embodiment

Hereinafter, a configuration of a MEMS display device as an embodiment of a display device of the invention will be described.

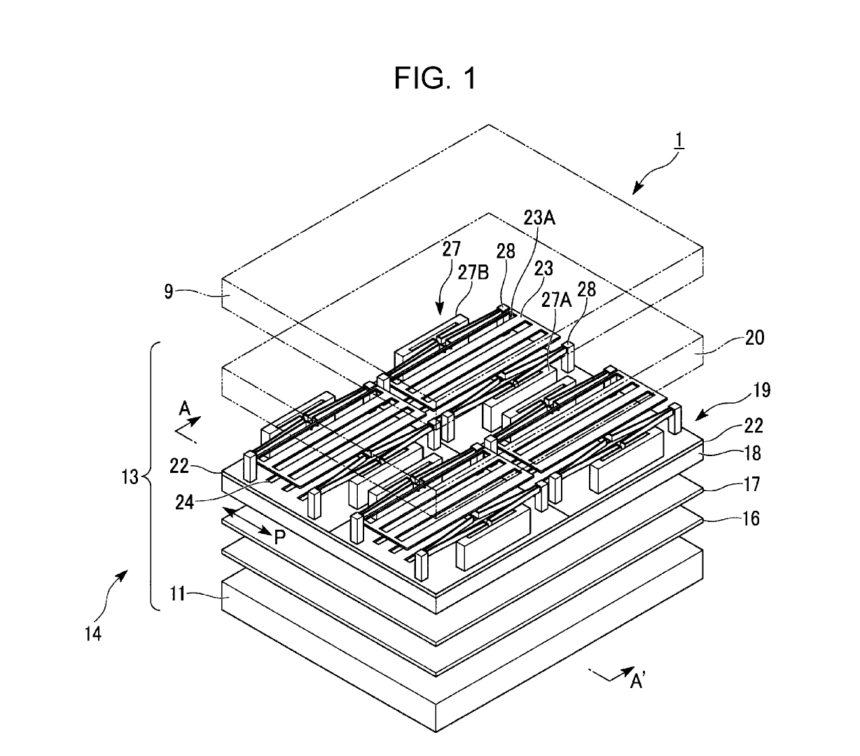

FIG. 1 is a diagram illustrating a schematic configuration of the MEMS display device according to a first embodiment. FIG. 1 mainly illustrates an array of shutter-based light modulators which is incorporated in the MEMS display device.

A MEMS display device (display device) 1 according to the embodiment is configured by including a display unit 14, and a light control film 9 which is configured to control a light distributing property of light output from the display unit 14.

The display unit 14 includes a MEMS element 13 which is provided with a plurality of shutter assemblies 19, and a backlight (lighting unit) 11.

The MEMS element 13 includes a luminance intensifying film 16, a diffuser 17, a light modulator substrate 18, the shutter assembly (light modulator) 19, and a cover plate 20.

A plurality of the shutter assemblies 19 are disposed on the light modulator substrate 18. Only four shutter assemblies are illustrated in FIG. 1, however, many shutter assemblies are arranged in a row direction and a column direction, in practice.

The shutter assembly 19 is operable such that a closed state in which passing through of light from the backlight 11 is shut off, and an open state in which passing through of light from the backlight 11 is allowed are selectively switched. According to the embodiment, each shutter assembly 19 is provided so as to correspond to one pixel in a display image, however, a plurality of the shutter assemblies 19 may be provided so as to correspond to one pixel.

The display unit 14 may form a display image using light passed through the shutter assembly 19 by selectively setting one or a plurality of shutter assemblies 19 corresponding to a specific display image to an open state, synchronously to driving of the backlight 11, for example.

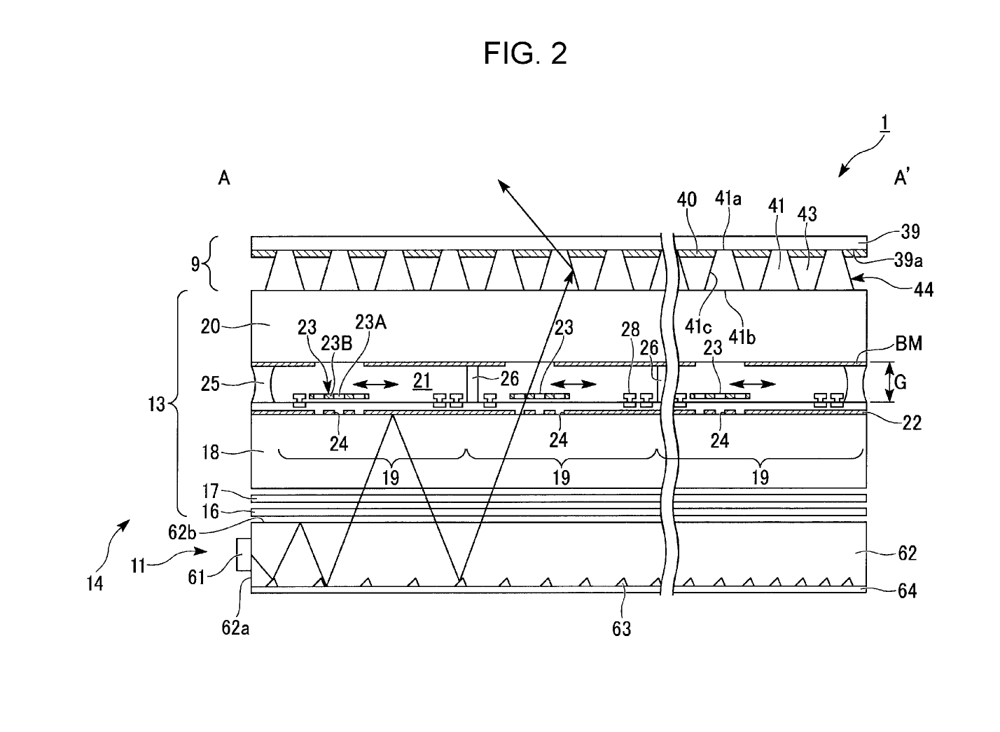

FIG. 2 is a sectional view illustrating a schematic configuration of the MEMS display device. As illustrated in FIG. 2, when a side on which the light control film 9 is disposed is set to the front side of the MEMS element 13, the backlight 11 is disposed on the rear side of the MEMS element 13 on the side opposite to the light control film 9.

The backlight 11 is provided with one or a plurality of light sources 61, a light guide 62, a plurality of prisms 63, and a reflective film 64. The backlight 11 according to the embodiment is an edge-lit backlight 11 in which the light source 61 is provided on a side end face (light input face 62a) of the light guide 62.

The light source 61 is configured of, for example, a plurality of light emitting diodes (LED) which are linearly aligned, and a light emitting unit of LED is disposed so as to face the light input face 62a of the light guide 62.

Since the LED has high color purity in general, is luminance stability, and has high-speed responsiveness, for example, the LED is widely used as a backlight light source. As the LED, a white LED which emits white light using one LED, or an LED which emits light of a single color of RGB is used. It is possible to obtain a wide color gamut performance using the LED which emits light of a single color of RGB. When the white LED is used, there are advantages of low cost, suppressing total power consumption based on the number of LEDs which may be needed, and the like. An incandescent lamp, a fluorescent lamp, or a laser may be used as the light source 61.

Light which is radiated from each light source 61 is input to the inside of the light guide 62 from the light input face 62a of the light guide 62, is guided while being diffused inside the light guide 62, and is output from the light output face 62b on the upper side (shutter assembly 19 side). A transparent material, that is, a glass or plastic material is used for the light guide 62. As the plastic material, an acrylic resin, a polycarbonate resin, a cycloolefin-based resin (COP), or the like is used.

The reflective film 64 is disposed on the rear face side of the light guide 62, and reflects light which is guided inside the light guide 62 toward the shutter assembly 19 side.

The plurality of prisms 63 are disposed on the surface of the reflective film 64, and function so that light which is input to the inside of the light guide 62 is efficiently guided to the shutter assembly 19 side. The plurality of prisms 63 are disposed with a certain gap between the prisms 63, and are disposed so as to be dense as the distance between the prisms 63 and the light source 61 becomes large.

A sectional shape of the prism 63 may be a trapezoid instead of a triangle. In addition, the plurality of prisms 63 may be formed integrally with the reflective film 64.

The luminance intensifying film 16 and the diffuser 17 of the display unit 14 are provided on the light output face 62b of the backlight 11 in this order.

The light modulator substrate 18 is disposed above the light output face 62b of the backlight 11 with the luminance intensifying film 16 and the diffuser 17 in between. The light modulator substrate 18 is provided for locking the shutter assembly 19 and is formed of a substrate with light permeability.

The shutter assembly 19 includes at least an aperture layer (light transmitting member) 22 and a shutter 23, and is provided on the surface (face opposite to backlight 11 side) of the light modulator substrate 18.

The aperture layer 22 includes a plurality of openings 24 which transmit light output from the backlight 11. Each opening 24 is subjected to pattern forming in each shutter assembly 19. As illustrated in FIG. 1, the plurality of openings 24 are arranged in matrix in a longitudinal direction (first direction) and a transverse direction (second direction) on the surface of the light modulator substrate 18. According to the embodiment, the transverse direction of the light modulator substrate 18 and a direction P in which an interval between openings 24 which are adjacent to each other is short substantially match.

The aperture layer 22 is formed of a reflective material or a light absorbing material. The aperture layer 22 according to the embodiment is made of a reflective material, and reflects light, which is input to a region other than the openings 24 (light which is not transmitted through openings 24), among light from the backlight 11 toward the backlight 11.

The shutter 23 switches between transmitting light from the backlight 11 through the opening 24 of the aperture layer 22 and shielding the light. The shutter is movable with respect to the opening 24 of the aperture layer 22, and is configured to move in a horizontal direction along the surface of the aperture layer 22. The shutter 23 is selectively moved between a light shielding position (closed state) in which light is shielded by covering approximately the entire opening 24 of the aperture layer 22 and a transmitting position (open state) in which light is caused to pass through by exposing the entire opening 24.

In a case in which the shutter assembly 19 is in the open state, the shutter 23 allows light from the backlight 11 to pass through the opening 24 of the aperture layer 22 and go toward a viewer (viewing side). In a case in which the shutter assembly 19 is in the closed state, the shutter 23 shields light from the backlight 11 which is transmitted through the opening 24 of the aperture layer 22. The opening/closing operation of the shutter 23 is controlled by a control unit (not illustrated).

The light modulator substrate 18 is bonded to the cover plate 20 through an adhesive seal 25.

The cover plate 20 is disposed above the shutter assembly 19. The rear face side of the cover plate 20 may be covered with a black matrix BM in order to increase contrast. The cover plate 20 is supported by being separated, by a predetermined distance, from the shutter assembly 19. A gap G which is formed between the cover plate 20 and the shutter assembly 19 is maintained by a spacer 26 and the adhesive seal 25.

The adhesive seal 25 seals working fluid 21 filling a portion of the gap G. The working fluid 21 functions as lubricant. A material of the working fluid 21 is not particularly limited, and may be de-ionized water, methanol, ethanol, silicone oil, fluorinated silicone oil, dimethyl siloxane, polydimethyl siloxane, hexamethyl disiloxane, and diethyl benzene. Alternatively, the working fluid may be hydrophobic liquid. The hydrophobic liquid can remove water from the surface of the shutter assembly 19. Air may fill the gap G as the working fluid 21.

It is possible to form the adhesive seal 25 by using a polymer adhesive such as epoxy, acrylate, or a silicon material.

The light control film 9 includes a transparent base member (base member) 39, and a light diffusing layer 44 and a light shielding layer 40 which are formed on a first face 39a of the transparent base member 39.

The light diffusing layer 44 includes a light diffusing portion 41 and a hollow portion 43. The light diffusing portion 41 is provided with a light output end face 41a which faces the transparent base member 39, and a light input end face 41b which is opposite the light output end face 41a and has an area larger than that of the light output end face 41a. The light diffusing layer 44 has a configuration in which a height from the light input end face 41b to the light output end face 41a is larger than a thickness of the light shielding layer 40. The light shielding layer 40 is formed in a region other than a region where the light diffusing portion 41 is formed on the first face 39a of the transparent base member 39.

Next, a configuration of the shutter assembly 19 will be described in detail. As illustrated in FIGS. 1 and 2, the shutter assembly 19 which is incorporated in the MEMS display device 1 includes two actuators 27 (first actuator 27A and second actuator 27B) which are connected to the above described shutter 23.

The first actuator 27A and the second actuator 27B are disposed on both sides of shutter 23 in the transverse direction, respectively, and are controlled independently from each other. The first actuator 27A functions so as to open the shutter 23. The second actuator 27B functions so as to close the shutter 23. The first actuator 27A and the second actuator 27B open or close the shutter 23 by moving the shutter 23 on a plane which is substantially parallel to the aperture layer 22.

The shutter 23 is suspended by anchors 28 which are attached to the first actuator 27A and the second actuator 27B, by being slightly separated from the aperture layer 22.

The shutter 23 includes a plurality of shutter openings 23A, and a light shielding region 23B. According to the embodiment, three shutter openings 23A are provided corresponding to the openings 24 of the aperture layer 22. Each of the shutter openings 23A transmits light which passed through each opening 24 of the aperture layer 22, respectively, and the light shielding region 23B shields the light which passed through each opening 24 of the aperture layer 22. When the shutter 23 is in the open position, each of the shutter openings 23A overlaps with a corresponding one of the openings 24 of the aperture layer 22 in plan view, and when the shutter 23 is in the closed position, each of the light shielding regions 23B overlaps with a corresponding one of the openings 24 of the aperture layer 22 in plan view.

The shutter openings 23A are subjected to pattern forming in a rectangular shape, similarly to the openings 24 of the aperture layer 22, and are formed into an opening having a size including the opening 24, that is, with an opening area which is larger than the area of the opening 24 of the aperture layer 22, in a case of being overlapped with the opening 24 of the aperture layer 22 in plan view.

In addition, the shutter opening has an area which can cover the entire opening 24 of the aperture layer 22, also in the light shielding region 23B. In addition, shapes of the shutter openings 23A and the opening 24 of the aperture layer 22 in plan view are not limited to the above described shape.

A side of the shutter 23 which faces the aperture layer 22 is covered with a substance having a light absorption property or a light reflective material in order to absorb or reflect light which is blocked. Alternatively, the shutter 23 may be made of a light absorbing substance or a light reflective material.

Next, shutter operations of the shutter assembly 19 will be described.

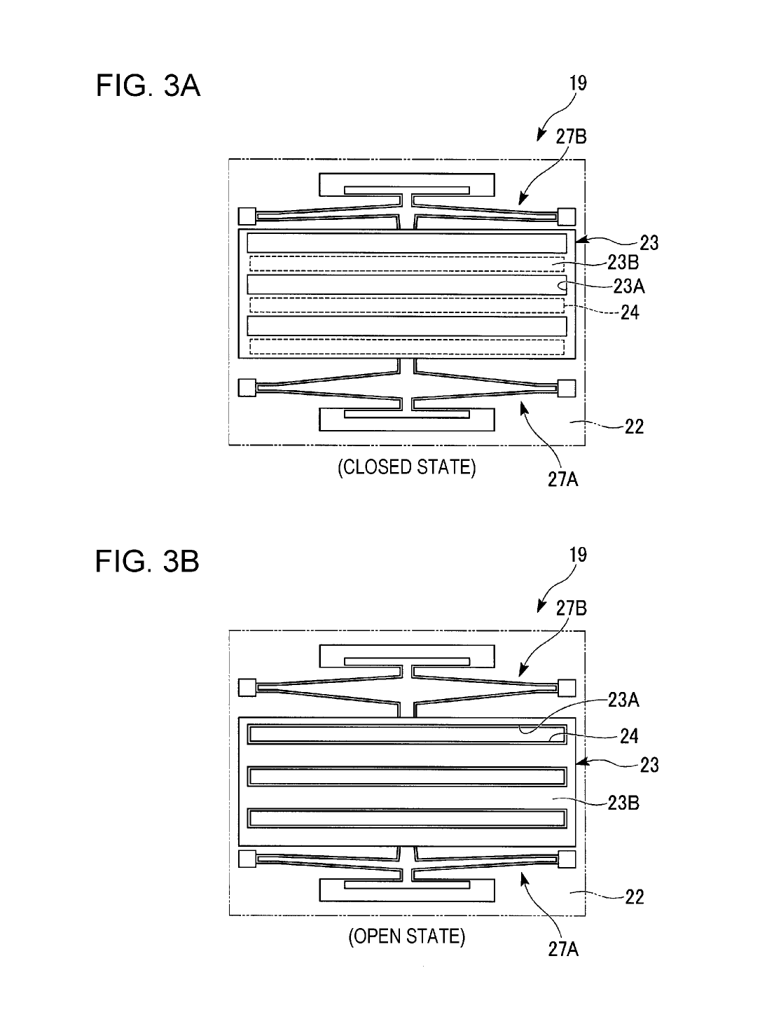

FIGS. 3A and 3B are diagrams which illustrate the shutter operations of the shutter assembly 19, in which FIG. 3A illustrates a closed state of the shutter assembly 19 and FIG. 3B is a diagram illustrating an open state of the shutter assembly 19.

(Closed State)

As illustrated in FIG. 3A, when the shutter assembly 19 is in the closed state, the first actuator 27A is at an open position, and the second actuator 27B is at a folding position. As a result, the shutter 23 is disposed at a position in which the light shielding region 23B covers approximately the entire openings 24 of the aperture layer 22.

(Open State)

As illustrated in FIG. 3B, when the shutter assembly 19 is in the open state, the first actuator 27A is at the folding position, and the second actuator 27B is at the open position. As a result, the shutter 23 is disposed at a position in which each of the shutter openings 23A is overlapped with a corresponding one of the openings 24 of the aperture layer 22 in plan view. It is possible to check the openings 24 of the aperture layer 22 through the shutter openings 23A. As described above, the shutter openings 23A have an opening area which is larger than the area of the openings 24 of the aperture layer 22. It is possible to expand an angular range of light which passes through the shutter openings 23A by using a difference in the dimension.

Next, a configuration of the light control film will be described in detail.

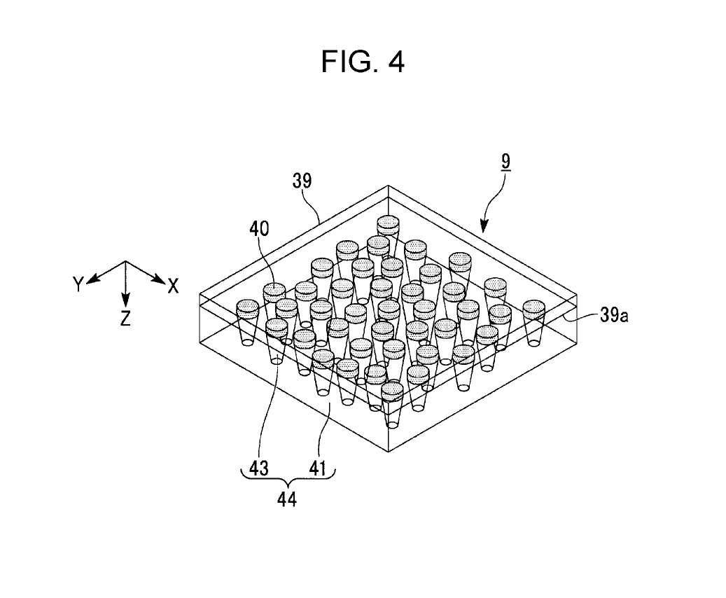

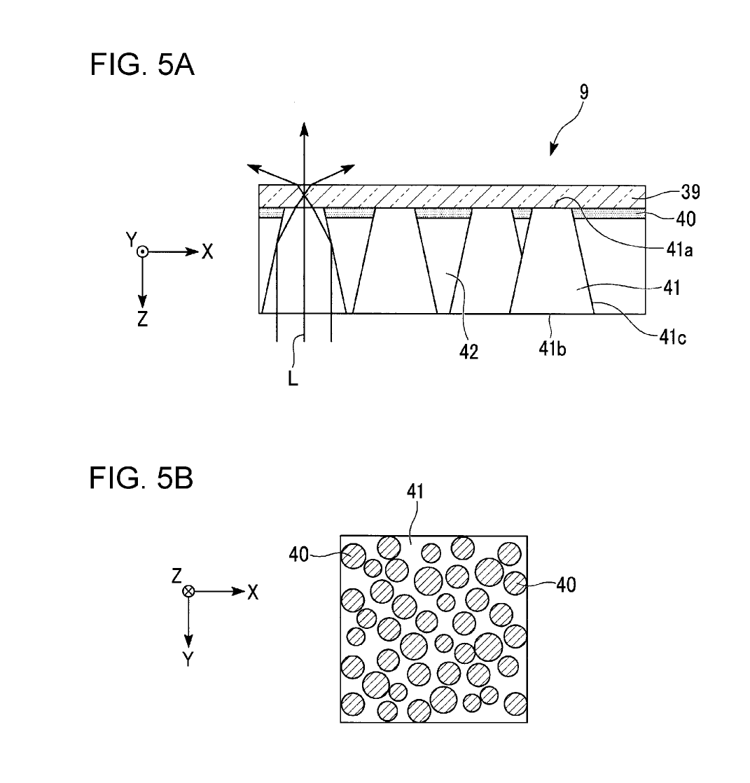

FIG. 4 is a perspective view illustrating a configuration of the light control film. FIG. 5A is a sectional view (sectional view in ZX direction) illustrating the light control film, and FIG. 5B is a plan view (plan view in XY direction) of the light control film. In FIG. 5B, the transparent base member 39 is not illustrated.

As illustrated in FIG. 4, the light control film 9 is configured of the transparent base member 39, the plurality of light shielding layers 40 which are formed on the first face 39a (face on side opposite to viewing side) of the transparent base member 39, and the light diffusing layer 44 which is formed on the first face 39a of the transparent base member 39. The light control film 9 is fixed to the cover plate 20 (see FIG. 2) through an adhesive layer (not illustrated) in a posture in which the light diffusing layer 44 side faces the cover plate 20 (see FIG. 2) and the transparent base member 39 side faces the viewing side.

The transparent base member 39 may preferably be made of, for example, a base member of a transparent resin such as a triacetylcellulose (TAC) film, polyethylene telephthalate (PET), polycarbonate (PC), polyethylene naphthalate (PEN), and polyether sulphone (PES) films. The transparent base member 39 is made into a base later, when applying a material of the light shielding layer 40 or light diffusing layer 44, in a manufacturing process which will be described later, and it may be necessary for the transparent base member to be provided with a thermal resistance and mechanical strength in a heat treatment process in the manufacturing process. Accordingly, a glass base member, or the like, may be used as the transparent base member 39, instead of the resin base member. In addition, it is preferable for the transparent base member 39 to have total light transmittance of 90% or more in a regulation of JIS K7361-1. When the total light transmittance is 90% or more, it is possible to obtain sufficient transparency. According to the embodiment, a base member of a transparent resin with a thickness of 100 μm is used, for example.

The plurality of light shielding layers 40 are formed so as to be dotted on the first face 39a of the transparent base member 39. As illustrated in FIG. 5B, the plurality of light shielding layers 40 are disposed in random when viewed from a direction (Z axis direction) normal to the transparent base member 39. According to the embodiment, a planar shape of each of the light shielding layers 40 is a circular shape.

The light shielding layer 40 is, for example, made of a layer which is formed of a black pigment, dye, a resin, or the like, with a light absorbing property and photosensitivity such as black resist containing carbon black. In a case of using a resin containing carbon black, or the like, since it is possible to form a film constituting the light shielding layer 40 in a printing process, an advantage that a use amount of a material is small, throughput is high, or the like, can be obtained. Other than that, a metal film such as a multilayer film of chrome (Cr), or chrome/chrome oxide may be used. In a case of using such a metal film or multilayer film, it is possible to obtain an advantage that light is sufficiently absorbed using a thin film, since optical density of these films is high.

According to the embodiment, for example, a diameter of each light shielding layer 40 is 20 μm, and coverage in the entire film is approximately 20%.

The light diffusing layer 44 is formed on the first face 39a of the transparent base member 39, and in a region except for the region where the plurality of light shielding layers 40 are formed. The light diffusing layer 44 is made of an organic material having light permeability and photosensitivity such as an acrylic resin or an epoxy resin, for example. It is preferable that total light transmittance of the light diffusing layer 44 is 90% or more in the regulation of JIS K7361-1. When the total light transmittance is 90% or more, it is possible to obtain sufficient transparency. A layer thickness of the light diffusing layer 44 is set to be sufficiently larger than that of the light shielding layer 40. In the embodiment, the layer thickness of the light diffusing layer 44 is approximately 25 μm, for example, and the layer thickness of the light shielding layer 40 is approximately 150 nm, for example.

As illustrated in FIG. 5A, the light diffusing layer 44 includes the light output end face 41a, the light input end face 41b, and a side face 41c. The light output end face 41a is a face which is in contact with the transparent base member 39. The light input end face 41b is a face which is opposite the light output end face 41a. The side face 41c is a tapered side face of the light diffusing portion 41. The side face 41c is a face which reflects light input from the light input end face 41b. An area of the light input end face 41b is larger than that of the light output end face 41a.

A hollow portion 43 of which a sectional area when being cut on a plane which is parallel to one face of the transparent base member 39 is large on the light shielding layer 40 side, and is in a shape which becomes gradually small as being separated from the light shielding layer 40 is formed in a region where the light shielding layer 40 is formed in the light diffusing layer 44. That is, the hollow portion 43 is formed in a so-called truncated conical shape which is forwardly tapered, when viewed from the transparent base member 39 side. Air exists inside the hollow portion 43. A portion other than the hollow portion 43 of the light diffusing layer 44, that is, a portion in which a transparent resin is continuously exists is a portion which contributes to transmitting of light. Accordingly, in the following description, the portion other than the hollow portion 43 of the light diffusing layer 44 is also referred to as the light diffusing portion 41. Light which is input to the light diffusing portion 41 is guided in a state of being approximately trapped inside the light diffusing portion 41, while being totally reflected on an interface between the light diffusing portion 41 and the hollow portion 43, and is output to the outside through the transparent base member 39.

As illustrated in FIG. 2, since the transparent base member 39 is disposed to face the viewing side in the light control film 9, a face with a small area (face on side which is in contact with transparent base member 39) becomes the light output end face 41a, and a face with a large area (face on side opposite to transparent base member 39) becomes the light input end face 41b in the two facing faces of the light diffusing portion 41. It is preferable to set an inclining angle (angle formed between light output end face 41a and side face 41c) of the side face 41c (interface between light diffusing portion 41 and hollow portion 43) of the light diffusing portion 41 to approximately 60° to 85°. However, as long as the inclining angle of the side face 41c of the light diffusing portion 41 is an angle in which a loss of input light is not that much large and it is possible to sufficiently diffuse the input light, it is not particularly limited.

According to the embodiment, since air exists in the hollow portion 43, when the light diffusing portion 41 is formed of, for example, a transparent acrylic resin, the side face 41c of the light diffusing portion 41 becomes an interface between the transparent acrylic resin and air. Here, a refractive index difference in an interface between the inside and the outside of the light diffusing portion 41 is large when the hollow portion 43 is filled with air, compared to a case in which the periphery of the light diffusing portion 41 is filled with other general materials with a low refractive index. Accordingly, due to the Snell's law, an input angle range in which light is totally reflected on the side face 41c of the light diffusing portion 41 is wide. As a result, it is possible to further suppress a loss of light, and obtain high luminance.

In addition, inert gas such as nitrogen, instead of air, may fill the hollow portion 43.

Alternatively, the inside of the hollow portion 43 may be in a vacuum state.

It is preferable that refractivity of the transparent base member 39 and refractivity of the light diffusing layer 44 are approximately equal. The reason for this is that, for example, when refractivity of the transparent base member 39 and refractivity of the light diffusing layer 44 are markedly different, unnecessary refraction or reflection of light occurs in an interface between the light diffusing layer 44 and the transparent base member 39 when light input from the light input end face 41b is going to be output from the light diffusing layer 44, and there is a concern that a desired viewing angle is not obtained, light intensity of output light is reduced, or other disadvantages may occur.

The light diffusing layer 44 is a portion which contributes to transmitting of light in the light control film 9. As illustrated in FIG. 5A, light L which is input to the light diffusing layer 44 is guided in a state of being approximately trapped inside the light diffusing layer 44, while being totally reflected on the side face 41c of the light diffusing layer 44, and is output from the light output end face 41a.

Next, a light distributing property of a transmission-type MEMS display device in the related art, and the transmission-type MEMS display device in the embodiment will be evaluated.

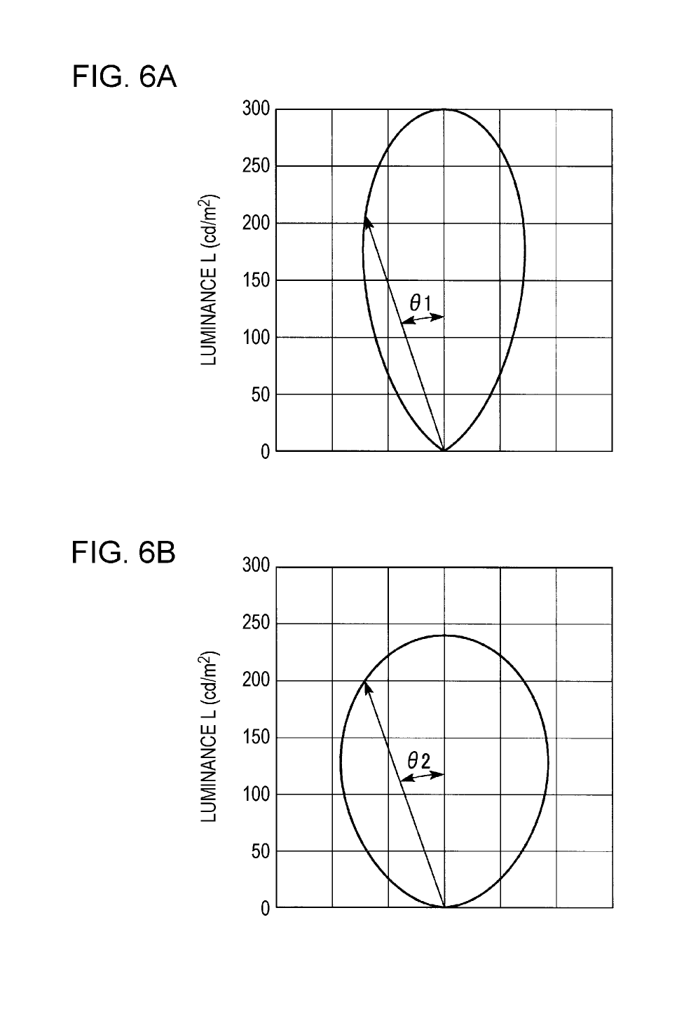

FIGS. 6A and 6B illustrate results of measuring a light distributing property of the transmission-type MEMS display device (light distributing angle-luminance), in order to prove an effect of the light control film, in which FIG. 6A is the MEMS display device in the related art (not having light control film), and FIG. 6B is the MEMS display device in the first embodiment (having light control film).

In addition, in FIGS. 6A and 6B, a vertical axis denotes luminance L (cd/m²). In addition, light distributing angles θ1 and θ2 on the front face of the display (direction normal to main face of display) is 0°.

As illustrated in FIGS. 6A and 6B, in the MEMS display device 1 according to the embodiment, luminance on the front face slightly decreases compared to that in the MEMS display device in the related art, however, a light distributing angle thereof is expanded (θ1<θ2). That is, the light control film 9 has a function of isotropically scattering light of which an output angle is controlled in the display unit 14 (MEMS element 13), and expanding thereof into a wide angle. As a result, it is possible to perform an image display with a wide viewing angle, since light which is output from the display unit 14 is diffused in a wide angle direction using the light control film 9.

In particular, according to the embodiment, since a planar shape of the light shielding layer 40 is circular, angular distribution expands to the entire azimuth in which a direction normal to the display screen of the MEMS display device 1 is set to a center. As a result, it is possible for a viewer to visually recognize good display in the entire azimuth. That is, it is possible to obtain a MEMS display device 1 which is excellent in a viewing angle property in accordance with a specification of the light control film 9.

In addition, according to the configuration of the embodiment, luminance unevenness of the backlight 11 does not appear directly in display, because the above described light control film 9 is provided on a display face side of the display. That is, it is possible to mitigate in-plane luminance unevenness of the display (backlight 11), when light from the backlight 11 is diffused in the light control film 9.

An amount of in-plane luminance unevenness from the backlight 11 is approximately ±40% before providing the light control film 9 on the display face side of the display, however, the amount of in-plane luminance unevenness from the backlight 11 is mitigated to approximately ±10%, after providing the light control film.

Accordingly, it is possible to perform an image display with good viewability, by providing the light control film 9.

In addition, a circular polarizer was disposed on the surface of a display in the related art in order to suppress reflection of outside light due to metal wiring and a metal shutter 23 of the MEMS element 13. In this case, however, light output from the backlight 11 (display unit 14) was cut by the circular polarizer, and intensity of output light of the display was decreased. For example, intensity of output light was decreased to approximately 40%, and a light loss of approximately 60% occurred due to the circular polarizer disposed.

In contrast to this, according to the embodiment, since the outside light is absorbed in the plurality of light shielding layers 40 by disposing the light control film 9 on the surface of the MEMS display device 1, it is possible to stop outside light from reaching the metal wiring of the MEMS element 13, the shutter 23, or the like. In addition, even when outside light is input to the MEMS element 13 and reflected light is generated, it is possible to stop the reflected light from being output from the display by being absorbed in the light shielding layer 40.

By adopting the configuration of the embodiment, it is possible to secure sufficient display luminance, since there is no need for providing the circular polarizer in order to suppress reflection due to outside light and therefore light from the backlight 11 is not markedly cut by the circular polarizer. Specifically, according to the embodiment, it is possible to suppress light loss of the backlight 11 up to 10%, approximately, and use light from the backlight 11 up to 90%, approximately. In addition, it is possible to suppress a reflection amount of outside light up to 50%, approximately, by providing the light control film 9 which includes the plurality of light shielding layers 40.

As described above, according to the embodiment, the MEMS display device 1 is provided in which bright display is performed by suppressing reflection of outside light, and display unevenness is suppressed by suppressing luminance unevenness.

In addition, according to the embodiment, the configuration is adopted in which the light control film 9 is disposed on the outermost face (face of cover plate 20 opposite to shutter assembly 19) on the viewer side of the display, however, the light control film 9 may be disposed on a face on the shutter assembly 19 side of the cover plate 20.

### Second Embodiment

Next, a MEMS display device according to a second embodiment will be described. A basic configuration of the MEMS display device in the embodiment is approximately the same as that in the first embodiment, however, a configuration of a light control film is different from that in the embodiment. In the following description, a portion different from the first embodiment will be described in detail, and description of common portions will be omitted.

In addition, constituent elements which are common to those in FIGS. 1 to 5B are given the same reference numerals in each figure which is used in description.

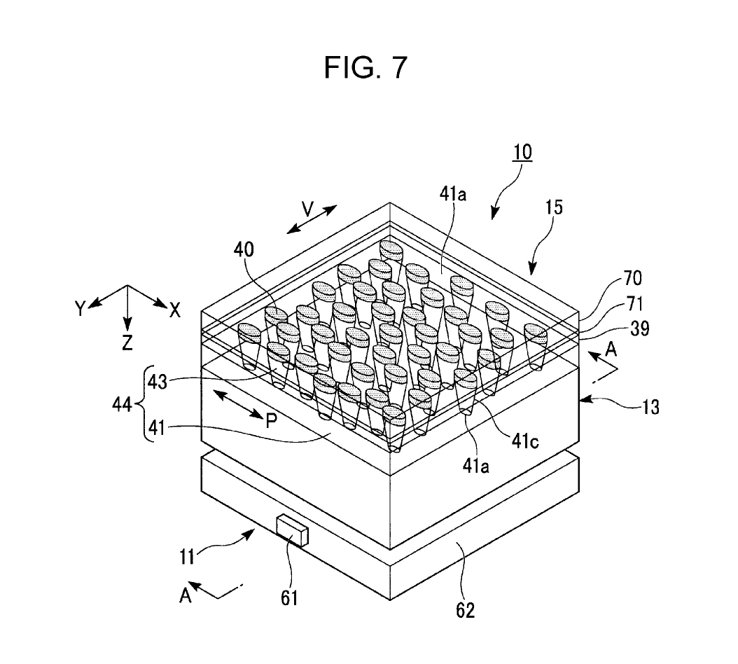

FIG. 7 is a perspective view illustrating a MEMS display device according to the second embodiment. As illustrated in FIG. 7, a MEMS display device (display device) 10 includes the display unit 14 which includes the backlight 11 and the MEMS element 13, and a light control film 15.

The light control film 15 according to the embodiment is schematically configured of a support base member 70, an adhesive layer 71, the transparent base member 39, the light shielding layer 40, and the light diffusing layer 44. The support base member 70 and the transparent base member 39 have light permeability to each other.

The support base member 70 is stacked on the transparent base member 39 through the adhesive layer 71 which is formed on one face (face on side opposite to first face 39a) of the transparent base member 39. A plurality of the light shielding layers 40, and the light diffusing layer 44 are formed on the other face (first face 39a) of the transparent base member 39.

According to the embodiment, a planar shape of each light shielding layer 40 which is viewed from a direction normal to the transparent base member 39 is set to an anisotropic shape with a long axis and a short axis. For example, as illustrated in FIG. 7, the planar shape of each light shielding layer 40 is set to an oval shape. For example, a length of the light shielding layer 40 in the longitudinal direction is 20 μm, and a length in the transverse direction is 10 μm. The plurality of light shielding layers 40 are disposed in random, similarly to those in the above described embodiment. In addition, in the plurality of light shielding layers 40, a long axis direction may be approximately parallel to each other.

The light diffusing layer 44 includes the light diffusing portion 41, and the plurality of hollow portions 43 which are formed in a region other than the region in which the plurality of light shielding layers 40 are formed, on the first face 39a of the transparent base member 39.

The light control film 15 in the embodiment anisotropically diffuses light which is input from the light input end face 41b of the light diffusing portion 41 in an azimuth angle direction which is viewed from a direction normal to the transparent base member 39. Since the shape of each of the light shielding layers 40 in plan view is the oval shape, light is diffused much in the short axis direction (Y direction) of the light shielding layer 40. Accordingly, it is configured so that an azimuth angle direction V of the light control film 15 in which a light diffusing property is relatively high, and an azimuth angle direction in which intensity of light output from the display unit 14 is low (direction in which an interval between openings 24 adjacent to each other is narrow, in aperture layer 22 which is illustrated in FIG. 1) P substantially match.

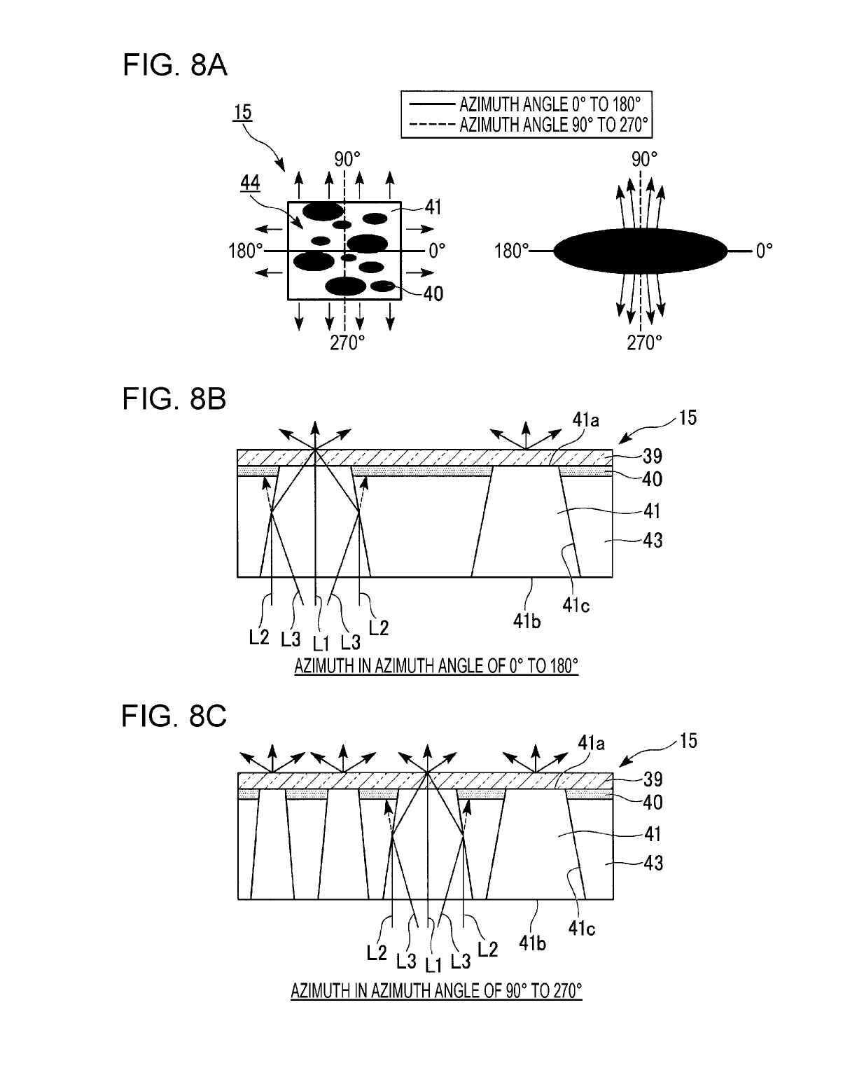

FIGS. 8A to 8C are diagrams which describe a shape of the light shielding layer of the light control film, and reflection of light on a side face of the light diffusing portion.

As described above, according to the embodiment, a planar shape of the light shielding layer 40 when viewing the light control film 15 (MEMS display device 10) from the front face (Z axis direction in FIG. 7) is formed in a dot shape which is vertically and horizontally asymmetric, as is represented by an oval shape, for example. That is, it is formed in a dot shape in which a light shielding width in a direction of an azimuth angle 0° to 180° which is denoted by one line in the figure is wide, and a light shielding width in a direction of an azimuth angle 90° to 270° which is denoted by a dotted line in the figure is narrow (refer to FIG. 8A).

Accordingly, in a case in which the light control film 15 is viewed in a sectional direction, a side area of the light diffusing portion (refer to FIG. 8B) in the direction of the azimuth angle 0° to 180° is set to be smaller than a side area of the light diffusing portion 41 (refer to FIG. 8C) in the direction of the azimuth angle 90° to 270°.

Accordingly, according to the light control film 15 in the embodiment, intensity of light which is output by being diffused in the direction of the azimuth angle of 0° to 180° becomes small, and intensity of light which is output by being diffused in the direction of the azimuth angle of 90° to 270° becomes large. That is, asymmetric light diffusing is executed depending on azimuth.

A planar shape of the light shielding layer 40 may be irregular in a peripheral edge shape thereof, as long as the shape is substantially orthogonal to certain azimuth, for example, azimuth in the azimuth angle of 90° to 270°. The diameter of dot which is asymmetric is not particularly limited to a certain size, and shapes of dot diameters with various sizes may be mixed. In addition, a disposition thereof is not limited to a regular disposition, and is not limited to a periodical disposition. In addition, dots of light shielding layers 40 may be formed by being overlapped with each other.

Here, an effect of expanding a viewing angle of the light control film will be described.

As illustrated in FIGS. 8B and 8C, among light which is input from the light input end face 41b to the inside of the light diffusing portion 41, light L1 which is almost perpendicularly input to the light input end face 41b in the vicinity of a center of the light diffusing portion 41 is not totally reflected on the side face 41c of the light diffusing portion 41, goes straight inside the light diffusing portion 41, and is transmitted.

In addition, since light L2 which is almost perpendicularly input to the light input end face 41b at the peripheral edge portion of the light diffusing portion 41 is input to the side face 41c of the light diffusing portion 41 with an input angle larger than a critical angle, the light is totally reflected on the side face 41c of the light diffusing portion 41. The totally reflected light refracts on the light output end face 41a of the light diffusing portion 41, and is output in a direction which forms a large angle with respect to a direction normal to the light output end face 41a.

Meanwhile, since light L3 which is obliquely input to the light input end face 41b of the light diffusing portion 41 is input to the side face 41c of the light diffusing portion 41 with an input angle which is smaller than the critical angle, the light is transmitted through the side face 41c of the light diffusing portion 41, and is absorbed into the light shielding layer 40.

According to the above described operations, light beams L1 and L2 which are almost perpendicularly input to the light control film 15 are output from the light control film 15 in a state in which angular distribution thereof is expanded compared to angular distribution before being input to the light control film 15. Accordingly, it is possible to visually recognize good display, even when an observer inclines his/her gaze from a front face direction (direction normal to display face) of the MEMS display device 10.

In particular, in the embodiment, since the planar shape of the light shielding layer 40 is an oval shape, angular distribution in the vertical direction of the MEMS display device is expanded, and it is possible to improve a viewing angle property in the vertical direction. For example, even in a case in which the backlight 11 has light distribution dependency (output direction dependency), and a viewing angle in a certain direction of the display becomes narrow, it is possible to perform display with good viewability by providing the light control film 15 so that light is diffused in this direction.

Hitherto, preferable embodiments according to the invention have been described while referring to accompanying drawings; however, it is needless to say that the invention is not limited to the examples. For a person skilled in the art, it is clear that various medication examples or correction examples can be perceived in a category of technical thoughts which are described in claims, and it is understood that those are naturally included in a technical scope of the invention.

### INDUSTRIAL APPLICABILITY

In one embodiment of the invention, it is possible to perform display with high viewability by suppressing reflection of outside light, and the embodiment can be applied to a display device, or other devices, in which it is necessary to suppress display unevenness by suppressing luminance unevenness.

### REFERENCE SIGNS LIST

1, 10 MEMS DISPLAY DEVICE (DISPLAY DEVICE)
9, 15 LIGHT CONTROL FILM
11 BACKLIGHT (LIGHTING UNIT)
14 DISPLAY UNIT
22 APERTURE LAYER (LIGHT TRANSMITTING MEMBER)
23 SHUTTER
24 OPENING
39 TRANSPARENT BASE MEMBER (BASE MEMBER)
39a FIRST FACE
40 LIGHT SHIELDING LAYER
41 LIGHT DIFFUSING PORTION
41a LIGHT OUTPUT END FACE
41b LIGHT INPUT END FACE
L1, L2, L3 LIGHT
P DIRECTION IN WHICH INTERVAL BETWEEN OPENINGS OF APERTURE LAYER WHICH ARE ADJACENT TO EACH OTHER IS NARROW
V AZIMUTH ANGLE DIRECTION IN WHICH LIGHT DIFFUSING PROPERTY OF LIGHT CONTROL FILM IS RELATIVELY HIGH

1: A display device comprising:
a display unit; and
a light control film configured to control a light distributing property of light output from the display unit,
the display unit including a lighting unit, a light transmitting member with an opening that transmits light output from the lighting unit, and a shutter that is movable with respect to the opening, and performing switching between transmitting and shielding of light through the opening,
the light control film including a base member having light permeability, a light diffusing portion formed on a first face of the base member, and a light shielding layer formed in a region other than a region where the light diffusing portion is formed on the first face of the base member, wherein
the light diffusing portion includes a light output end face in contact with the base member, and a light input end face that is opposite the light output end face and has an area larger than that of the light output end face, in which a height from the light input end face to the light output end face is larger than a thickness of the light shielding layer.

2: The display device according to claim 1, wherein
the shutter is made of a material having light reflectivity.

3. The display device according to claim 1, wherein
the light control film anisotropically diffuses light input from the light input end face in an azimuth angle direction which is viewed from a direction normal to the base member.
